(19) United States
(12) Patent Application Publication
(10) Pub. No.: US 2012/0096179 A1
(43) Pub. Date: Apr. 19, 2012

(54) Method For Processing Initial SIP Requests By Backends Of A SIP Cluster In The Presence Of A Fault, And Associated Processing Device

(75) Inventors: Dimitri Tombroff, Massy (FR); Yannick Bourget, Nozay (FR)

(73) Assignee: ALCATEL LUCENT, Paris (FR)

(21) Appl. No.: 13/172,349

(22) Filed: Jun. 29, 2011

(30) Foreign Application Priority Data
Oct. 18, 2010 (EP) 10306136.2

(51) Int. Cl. G06F 15/16

(52) U.S. Cl. 709/230

(57) ABSTRACT

A device (D) is devoted to processing initial SIP requests for an end-processing software module (B1), hereafter known as a backend and belonging to a SIP cluster operating for an application within a communication network (R). This device (D) is configured, whenever its backend (B1) has received an initial SIP request associated with a call identifier, to locally determine whether that identifier (B1) has already received an identical initial SIP request, and if so, to assume that the received initial SIP request has been retransmitted and process that retransmission, or if not, to determine within a table, offering a match between call identifiers associated with previously received initial SIP requests, and backend identifiers (B1-B3) that have received these initial SIP requests, and if there is another backend (B2) of the SIP cluster that has an identifier matching the call identifier associated with the received initial SIP request, in order to process this request if there is not; or alternatively, if there is, to receive the second backend's (B2) identifier in order to tell that second backend (B2) that it must process a retransmission of a previously received initial SIP request associated with the same call identifier as the received initial SIP request.

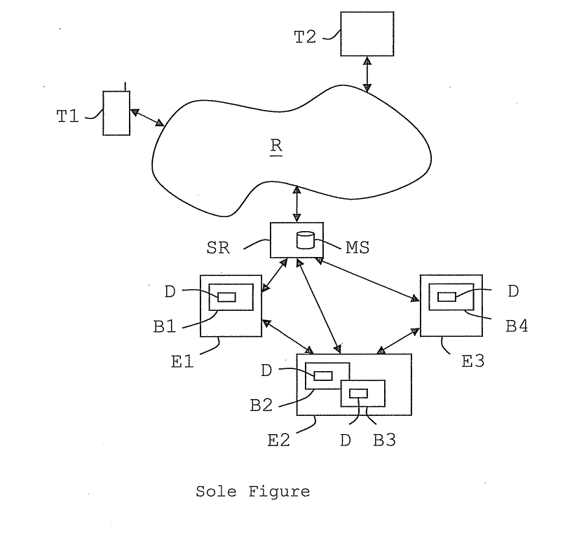

### TECHNICAL FIELD

The invention pertains to the processing of so-called initial SIP requests, within communication networks, and more specifically the processing of initial SIP requests by end-processing software modules (or “SIP backends”) of distributed applications belonging to clusters of SIP backends, subsequent to a failure or fault.

Here, the term “initial SIP request” refers to an SIP (“Session Initiation Protocol”) request that is intended to request the establishment (or creation) of a new SIP session. Furthermore, the term “retransmission of an initial SIP request” as used below refers to a SIP request that is in all ways identical to the initial SIP request (and in particular one having the same call identifier (or “Call-id”)), and which was sent in the absence of a response to the preceding initial SIP request.

### STATE OF THE ART

SIP application servers of the server or proxy type work with SIP clusters comprising SIP backends which are functionally identical. This enables scaling-up or high uptime (or high performance). Inbound traffic related to a SIP cluster is received by an input load balancer, associated with that SIP cluster, and tasked with distributing inbound messages to the relevant backends of its SIP cluster.

A SIP backend comprises a dedicated SIP container that is in charge of managing low-level SIP sessions and transactions. A SIP container is an execution environment for an end application that is tasked with processing a received SIP request, which is generally configured in the form of a “servlet” or a servlet-type module.

As the backends of a single SIP cluster may be installed in different network elements (or equipment), or in the same network element (or equipment), the associated SIP container may therefore be installed in those respective different network elements (or equipment) or in the same network element (or equipment).

### SUMMARY OF THE INVENTION

As is known to the person skilled in the art, it has been proposed to save, in memory of an input load balancer associated with a cluster of backends, a lookup table that matches call identifiers (or “Call-ids”), associated with first initial SIP requests, to backend identifiers, which are the recipients of those first initial SIP requests. Thus, whenever an initial SIP request associated with a call identifier is received by that input load balancer, it determines in its lookup table if there is a backend identifier that is stored as a match for that call identifier. If there isn't, it randomly selects a backend in order to transmit the received initial SIP request to it, and stores a new input in its lookup table matching the call identifier of that initial SIP request to that backend's identifier. Conversely, if there is, the received initial SIP request is transmitted to the backend whose identifier is matched in the table to the call identifier that is associated with that initial SIP request. In the event that there is a fault in the operation of the recipient backend of the initial SIP request, all inputs regarding that faulty backend are deleted from the input load balancer's lookup table.

It should be noted that a call identifier alone is not sufficient to make it possible to determine a packet that has been retransmitted. However, the use of a call identifier is sufficient, because a transmitted packet and a re-transmitted packet have the same call identifier.

The algorithmic solution given above is simple and effective. However, it does not make it possible to handle situations in which the faultiness or failure of a transmission results from the input load balancer. This is because, if that load balancer is faulty or if it is restarted (on the same equipment or on a backup equipment), it will use an empty or out-of-date lookup table. Furthermore, the failure of an input load balancer could cause a large number of initial SIP request retransmissions, given that it generally takes several seconds to detect that failure and then restart. Consequently, in the first few seconds to follow its restart (or boot-up), an input load balancer might receive a large number of initial SIP requests (retransmitted by communication terminals) that it will randomly address to various backends of its SIP cluster. The backends which are not the correct recipients of the retransmitted initial SIP requests will then consider these requests to be new initial SIP requests (meaning that they are being transmitted for the first time), which they will process conventionally (in accordance with the SIP protocol), which will mislead (or dupe) the end application (or servlet) in question, and therefore prevent its consistency from being guaranteed. As a reminder, the SIP container must particularly guarantee that an end application will never be recalled multiple times for a single SIP transaction in different backends of the same SIP cluster.

Multiple solutions have been proposed to attempt to make up for the aforementioned drawback.

Thus, it has been proposed to store the context of each SIP transaction in a database associated with a SIP cluster, so that each backend of that SIP cluster can manage each SIP message from any SIP transaction. In fact, any backend can execute the following process for each SIP transaction of each SIP session, and therefore the situation whereby an initial SIP request is retransmitted and is de facto correctly resolved. Of course, this solution is burdensome, but it is reasonable given the high performance that is required. However, this solution exhibits a notable drawback. Specifically, it imposes severe constraints on the end application, given that each application context associated with a SIP dialogue must be included in the SIP session data and SIP transaction data that is stored. In fact, the end application cannot use any local resources of a backend that is not the true recipient of a retransmitted initial SIP request, such as its timers. Consequently, the processing must ultimately be redirected to the appropriate backend, because this backend is the one that has the timers and other usable local resources, which amounts to transferring the problem from the SIP transaction engine to the application. This solution therefore causes a heavy limitation in performance and has proven too complicated to manage for an end application.

One variant of the aforementioned solution consists of replicating the SIP servlet sessions (and not the SIP transactions) into the backends by means of a dummy replication policy. In practice, each SIP session is replicated into two different backends of the same SIP cluster. The SIP session is only replicated when necessary, i.e. once the SIP dialogue has been established. This solution is more effective than the previous ones because it does not require a dedicated and separate database, which substantially reduces the number of messages exchanged. Since the SIP sessions are replicated, and can therefore be located within a SIP cluster, it is possible to verify whether an initial SIP request (which is not yet locally known in a backend) results from a retransmission of a SIP request previously received in a different backend. However, the call identifier does not constitute a SIP session key, and for cost reasons, a SIP session is not normally rendered persistent when the initial SIP request is received, but rather when switching to the state of an established SIP session. Consequently, the SIP session is created too late to help confirm that an initial SIP request is a retransmitted SIP request.

It should be noted that in theory, the problem of a failure could be directly processed within the input load balancers. Thus, in each SIP cluster, two input load balancers could be used with duplicate lookup tables (or databases). Unfortunately, whenever one of the input load balancers of a SIP cluster is faulty and is restarted, it must resynchronize with the other duplicate lookup table, which potentially has become larger, or else verify upon request whether a call identifier of a new SIP request is not already contained within the other duplicate lookup table, in order to ultimately fill in its own lookup table, without which a failure by the second load balancer would lead to a permanent loss of information. This operating mode requires the use of temporary queues, which could endanger the input load balancers.

It would also be possible to use hash functions to uniquely associate call identifiers with backend identifiers. However, the input load balancer would be faced with a problem every time a backend joined or left its SIP cluster, given that this would lead to a change in its hash function, and/or it would be incapable of choosing a backend based on certain criteria, such as its load or response time.

A particular purpose of the invention is to enable failure or fault management that requires a minimal amount of additional traffic within a communication network. It should be noted that the invention does not relate to the transmission to a single backend of SIP messages which are subsequent to the actual creation of a SIP session, nor does it relate to a communication terminal actually joining an existing SIP session.

According to a first aspect, the invention proposes a method dedicated to processing initial SIP requests within a SIP cluster of backends operating for an application within a communication network, and wherein, whenever a first backend of the SIP cluster receives an initial SIP request associated with a call identifier, it is locally determined whether it has already received an identical initial SIP request, and if it has, that first backend assumes that the received initial SIP request has been retransmitted and processes that retransmission, whereas if it hasn't, it is determined within a table that offers a match between call identifiers, associated with previously received initial SIP requests, and backend identifiers that have received those initial SIP requests, if there is a second backend of the SIP cluster that has an identifier matching the call identifier associated with the received initial SIP request, and if there isn't, the first backend processes the received initial SIP request, whereas if there is, the second backend's identifier is provided to the first backend so that it can tell the second backend that it must process a retransmission of a previously received initial SIP request associated with the same call identifier as that of the received initial SIP request.

The method of the invention may comprise other characteristics, which may be taken separately or in combination, in particular:
the first backend may send the second backend a notification that comprises the call identifier of the received initial SIP request, or it may transmit the received initial SIP request to the second backend for it to process;
whenever there is no backend that has an identifier matching the call identifier associated with the received initial SIP request, a new match may be created in the table between the latter call identifier and the identifier of the first backend;
the table may be a hash table that is potentially distributed among at least two different backends of the SIP cluster.

According to a second aspect, the invention proposes a device dedicated to processing initial SIP requests for a backend belonging to a SIP cluster operating for an application within a communication network, and configured, whenever its backend has received an initial SIP request associated with a call identifier, to locally determine whether that backend has already received an identical initial SIP request, and if it has, to assume that the received initial SIP request has been retransmitted and process that retransmission, whereas if it hasn't, to determine within a table that offers matches between call identifiers, associated with previously received initial SIP requests, and backend identifiers that have received those initial SIP requests, if there is another backend of the SIP cluster that has an identifier matching the call identifier associated with the received initial SIP request, and if there isn't, to process it, whereas if there is, to receive the second backend's identifier in order to tell the second backend that it must process a retransmission of a previously received initial SIP request associated with the same call identifier as that of the received initial SIP request.

The inventive device may comprise other characteristics, which may be taken separately or in combination, in particular:
it may send the second backend a notification that comprises the call identifier of the received initial SIP request, or it may transmit the received initial SIP request to the second backend for it to process;
it may be configured, whenever there is no backend with an identifier matching the call identifier associated with the received initial SIP request, to initiate the creation of a new match within the table between the latter call identifier and the identifier of the first backend;
it may be configured to store part of a table that appears in the form of a distributed hash table.

According to a third aspect, the invention proposes a communication equipment, capable of being connected to a communication network, and comprising at least one backend belonging to a SIP cluster operating for an application and comprising a processing device of the type presented above.

### BRIEF DESCRIPTION OF THE DRAWING

Other characteristics and advantages of the invention will become apparent upon examining the detailed description below, in which the attached drawing very schematically and functionally depicts a communication network, to which there are connected communication terminals and a load-balancing server coupled to three communication equipments each comprising at least one backend equipped with a processing device according to the invention.

The drawing may serve not only to complete the invention, but also to contribute to defining it, if need be.

### DETAILED DESCRIPTION

It is an object of the invention to make it possible to process initial SIP requests within a SIP cluster of end processing software modules (Bi), hereafter known as backends and operating for an (end) application within a communication network (R).

It should be noted that the invention related to any type of communication network, whether it is wired or wireless (or radio). As a reminder, the SIP protocol offers independence with respect to the protocol's transport layer.

The sole FIGURE schematically depicts a communication network R to which are connected communication terminals Tk, belonging to users, and a server SR acting as an input load balancer for a cluster of SIP backends BI (hereafter known as a SIP cluster).

Here, the term “communication terminal” refers to any communication equipment that can connect to a communication network and that has at least one SIP (“Session Initiation Protocol”) client capable of dialoguing with a SIP server during a SIP session established in a client/server environment. Consequently, it may be a landline or mobile (or cellular) telephone, potentially a “smartphone”; or a desktop or portable computer, a personal digital assistant (or PDA), a multimedia content receiver (such as a decoder, a residential gateway, or an STB (“Set-Top Box”)), or a communicating gaming console, for example.

In the non-limiting example depicted, the letter k takes on the values 1 and 2, but the number of communication terminals Tk that are or can be connected to the communication network R may be equal to any value greater than or equal to one (1).

The server SR is a SIP server and may be coupled to one or more application servers Ej, which are also of the SIP type, each comprising at least one backend Bi belonging to a SIP cluster operating for a function.

Each application servers Ej is, for example, of the server (potentially B2BUA (“Back-to-Back User Agent”)) or proxy type.

In the non-limiting example depicted, the letter j takes on the values 1 to 3, but the number of application servers Ej coupled to the same load-balancing server SR may be equal to any value greater than or equal to one (1). This is because it is conceivable that all the backends Bi of a SIP cluster are installed in the same application server or in a communication equipment (or element) of another type.

Furthermore, in the non-limiting example depicted, the first E1 and third E3 application server(s) each comprise a backend B1 (i=1) or B4 (i=4), while the second application server E2 comprises two backends B2 (i=2) and B3 (i=3). However, each of the application servers Ej might comprise only a single backend Bi, or multiple (at least two) backends Bi.

As a reminder, the load-balancing server SR is particularly tasked with receiving inbound SIP messages (requests or reply messages) which are intended for the backends Bi of its SIP cluster, in order to distribute them to those backends Bi. It also comprises storage means MS which are tasked with storing a table offering a match between call identifiers, associated with initial SIP requests previously received by the backends Bi of its SIP cluster, and identifiers of those backends (Bi). This table may be a lookup table configured in the form of a database. However, in one variant it may be configured in the form of a hash table, meaning a table that uniquely provides a backend Bi identifier whenever a call identifier is provided to its hashing function

In what follows, it is assumed, by way of an illustrative example, that the SIP requests and SIP response messages that the application servers Ej exchange with one another or transmit to the communication terminals Tk all travel through the load-balancing server SR, which serves as an interface with the communication network R. However, this is not obligatory.

As another reminder, each SIP backend Bi supports a dedicated SIP container that is in charge of managing low-level SIP sessions and transactions.

As a final reminder, a SIP container is an execution environment for an (end) application tasked with processing a SIP request received by the load-balancing server SR associated with (or dedicated to) its SIP cluster. It is assumed in what follows, by way of a nonlimiting example, that the (end) application is configured in the form of a “servlet” or servlet-type module. However, this is not obligatory. Furthermore, it is assumed in what follows, by way of a non-limiting example, that the (end) application and the SIP container are installed in each application server Ej. However, this is not obligatory.

The invention particularly proposes implementing a method for processing SIP requests within a communication system of the type described above with reference to the sole FIGURE.

This method may be implemented by means of processing devices D respectively associated with the backends Bi of a SIP cluster. Here, the word “associated” means both forming an integral part of a backend Bi (as depicted) or being coupled directly or indirectly to a backend Bi. Consequently, a processing device D may be constructed in the form of software (or computer) modules, or electronic circuits, or a combination of electronic circuits and software modules. The method is implemented in a SIP cluster every time a first backend Bi (for example, B1) of that SIP cluster receives from its load-balancing server SR an initial SIP request associated with a call identifier (or “Call-id”) and coming from a communication terminal Tk.

In this situation, the device D associated with that first backend B1 locally determines whether that first backend B1 has already received an identical initial SIP request. As a reminder, each backend Bi temporarily saves the log of each initial SIP request that it receives and the log of the response resulting from the local processing of each received initial SIP request. This particularly enables it to retransmit to a communication terminal Tk, which retransmits an initial SIP request to it due to the failure to receive a response to a previous initial SIP request identical to that one, a response which is identical to the one previously transmitted but which had not been received. The failure by a communication terminal Tk to receive a response message may have any origin whatsoever, and particularly a transmission problem over the communication network R, a fault of the load-balancing server SR that serves as an interface between the communication network R and the backends Bi, a fault in reception of the communication terminal Tk, or a fault in transmission of the application server Ej that contains the backend Bi which generated the response message.

If it turns out that the first backend B1 already received an identical initial SIP request, then the first backend B1 (and more specifically, its associated device D) assumes that it is a retransmission that concerns it, and therefore processes that retransmission. This processing is entirely conventional (and compliant with the SIP protocol). It consists simply of responding by a message that comprises a response identical to the one previously transmitted subsequent to the processing of the same initial SIP request (meaning associated with the same call identifier).

On the other hand, if it turns out that the first backend B1 did not receive an identical initial SIP request, then the first backend B1 (and more specifically, its associated device D) determines, by means of a request, within a table that offers a match between call identifiers, associated with previously received initial SIP requests, and backend identifiers (Bi) that received those initial SIP requests, if there is a second backend Bi′ (i′≠1, for example i′=2) in its SIP cluster that is associated with an identifier and matches the call identifier associated with the received initial SIP request.

It should be noted that the table may be stored in at least one application server Ej, potentially in a distributed fashion, and/or into another communication element or equipment (not depicted) that is accessible to the application servers Ej, and which is different from the load-balancing server SR. It should also be noted that the request intended to make a determination within that table does not necessarily travel through the load-balancing server SR.

This table may be a lookup table configured in the form of a database. However, in one advantageous variant, it may be configured in the form of a hash table, meaning a table that uniquely provides a backend Bi identifier whenever a call identifier is provided to its hashing function. Even more advantageously, the hash table may be distributed among at least two backends Bi of the same SIP cluster.

The distribution of the hash table among multiple backends Bi implies both smaller subtables and that multiple backends Bi hold different match information. The search for a match may therefore be done in parallel for call identifiers distributed across different parts of the hash table, which enables it to work faster. It should be noted that, out of a desire for system robustness, each table (or sub-table) part must be replicated across multiple (n) backends Bi, in order to compensate for a situation in which one of the backends Bi that holds a replica becomes unavailable subsequent to a failure or restart. Furthermore, in the event of a failure in the backend Bi containing a replica of a sub-table, it is advantageous to choose another backend Bi′ where that sub-table can be replicated so as to guarantee that n copies of that sub-table exist and are accessible at all times. Breaking down and distributing a table into smaller subtables each replicated n times therefore improves the performance of the replication mechanism described above.

It should be noted that the entries in the table do not necessarily need to be explicitly deleted at the end of a SIP transaction. Rather, they may themselves disappear after a preset elapsed time. This makes it possible to keep the backends Bi from having to transmit additional messages intended to request that an entry be deleted.

If it turns out that the queried table does not contain a backend Bi′ identifier that matches the call identifier associated with the initial SIP request in question, this means that that request is being transmitted for the first time and therefore is not a retransmission. A response message is then addressed to the first backend B1 telling it that it is in charge of processing (by means of its associated device D) the initial SIP request that it has just received.

This processing is entirely conventional (and compliant with the SIP protocol). As a result, a response message is generated, intended for the communication terminal Tk that transmitted the initial SIP request in question. On the other hand, if it turns out that the queried table does contain an identifier of the second backend Bi′ (for example i′=2) that matches the call identifier associated with the initial SIP request in question, this means that the request is being retransmitted. A response message is then sent to the first backend B1 containing the identifier of the second backend B2, so that it (and more specifically its associated device D) can tell that second backend B2 that it must process a retransmission of an initial SIP request that it had previously received (and processed) and which is associated with the call identifier of the initial SIP request received by the first backend B1.

This retransmission processing is entirely conventional (and compliant with the SIP protocol). As a result, a new response message is generated, identical to the one that had previously been generated in response to the previous received SIP request associated with the same call identifier, and intended for the same communication terminal Tk.

It should be noted that, unlike what is done in the prior art, the load-balancing server SR no longer intervenes here to randomly determine a new backend Bi intended to process the last SIP request received once it became apparent that the table did not contain an entry for the call identifier of that last SIP request. The first backend B1, which received that last SIP request, is the one automatically tasked with processing it.

It should also be noted that in order to determine a backend Bi identifier within the table, a “create/get” request intended for that table may advantageously be used, this being well-known to the person skilled in the art. This is because such a request makes it possible not only to obtain a response to a “get” request for the backend Bi identifier, by means of a SIP response message, but also to automatically update the table by potentially creating within that table a new match between a call identifier and an identifier of the first backend B1, designated within the aforementioned “get” request, if an identifier of the second backend Bi′ is not determined within said table (i′≠1). As a result, when an update is performed, the response message that is transmitted to the first backend B1 is intended to indicate that update to that backend (B1).

Owing to the automatic real-time updating of the table, the SIP cluster at all times has a source of reliable information that may particularly be used by the load-balancing server SR in order to update its own table (stored within its storage means MS) once it has experienced a failure. Thus, once the load-balancing server SR receives a SIP request associated with a call identifier whose match is up-to-date in the table, it is capable of transmitting it to the backend Bi in question, with no error and without having to determine a backend Bi identifier at random.

It should also be noted that whenever the identifier of a second backend B2 has been determined within the table, the first backend B1 (and more specifically its associated device D) may either address a notification to that second backend B2, comprising the call identifier of the last initial SIP request received, or may transmit that last received initial SIP request to the second backend B2 for it to process. The first solution is currently preferred, because it only requires one message (or notification) containing very little data, unlike a complete initial SIP request.

The invention only leads to a minimal additional load on the communication network. This is because it requires one “create/get” transaction to the table (a request to determine a backend identifier in the table and a response message to that request), and potentially a notification intended to tell a second backend that it must proceed with a retransmission of the response message. Additionally, the backend determination requests and the corresponding response messages, and the notifications, are small and may efficiently be aggregated and intercalated within the traffic between backends in order to further limit the load on the network.

Furthermore, the invention keeps the load-balancing server from specifically processing retransmissions, which is not its role, by distributing this supplementary task among the backends. In fact, thanks to the invention, the load-balancing server performs its own task without intervening in the operations related to the top-layer protocol that could lead to architecture problems and harm its performance.

The invention is not limited to the embodiments of the processing method, first processing device, and communication equipment described above, which are given only as examples, but rather encompasses all variants that the person skilled in the art may envision within the framework of the claims below.

1. A method for processing initial SIP requests within a SIP cluster of end processing software modules, hereafter known as backends and operating for an application within a communication network, wherein, whenever a first backend of said SIP cluster receives an initial SIP request associated with a call identifier, it is locally determined whether it has already received an identical initial SIP request, and if it has, said first backend assumes that the received initial SIP request has been retransmitted and processes that retransmission, whereas if it hasn't, it is determined within a table that offers a match between call identifiers, associated with previously received initial SIP requests, and backend identifiers that have received those initial SIP requests, if there is a second backend of said SIP cluster that has an identifier matching the call identifier associated with said received initial SIP request, and if there isn't, said first backend processes said received initial SIP request, whereas if there is, said second backend's identifier is provided to said first backend so that it can tell the second backend that it must process a retransmission of a previously received initial SIP request associated with the same call identifier as that of said received initial SIP request.

2. A method according to claim 1, wherein said first backend sends said second backend a notification that comprises said call identifier of said received initial SIP request.

3. A method according to claim 1, wherein said first backend transmits said received initial SIP request to said second backend for it to process.

4. A method according to claim 1, wherein, whenever there is no backend with an identifier matching the call identifier associated with said received initial SIP request, to create a new match within said table between the latter call identifier and the identifier of said first backend.

5. A method according to claim 1, wherein said table is a hash table.

6. A method according to claim 5, wherein said hash table is distributed among at least two backends of said SIP cluster.

7. A device for processing initial SIP requests for an end processing software module, hereafter known as a backend and operating for an application within a communication network, wherein, and configured, whenever said backend has received an initial SIP request associated with a call identifier, to locally determine whether that backend has already received an identical initial SIP request, and if it has, to assume that said received initial SIP request has been retransmitted and process that retransmission, whereas if it hasn't, to determine within a table that offers matches between call identifiers, associated with previously received initial SIP requests, and backend identifiers that have received those initial SIP requests, if there is another backend of said SIP cluster that has an identifier matching the call identifier associated with said received initial SIP request, and if there isn't, to process it, whereas if there is, to receive said second backend's identifier in order to tell said second backend that it must process a retransmission of a previously received initial SIP request associated with the same call identifier as that of said received initial SIP request.

8. A device according to claim 7, configured to sends said second backend a notification that comprises said call identifier of said received initial SIP request.

9. A device according to claim 7, configured to transmit said received initial SIP request to said second backend for it to process.

10. A device according to claim 7, configured, whenever there is no backend with an identifier matching the call identifier associated with said received initial SIP request, to initiate the creation of a new match within said table between the latter call identifier and the identifier of said first backend.

11. A device according to claim 7, configured to store part of a table that appears in the form of a distributed hash table.

12. A communication equipment capable of being connected to a communication network, and comprising at least one end processing software module, hereafter known as a backend and belonging to a SIP cluster operating for an application, wherein each backend comprises a processing device according to claim 7.

13. A communication equipment capable of being connected to a communication network, and comprising at least one end processing software module, hereafter known as a backend and belonging to a SIP cluster operating for an application, wherein each backend comprises a processing device according to claim 8.

14. A communication equipment capable of being connected to a communication network, and comprising at least one end processing software module, hereafter known as a backend and belonging to a SIP cluster operating for an application, wherein each backend comprises a processing device according to claim 9.

15. A communication equipment capable of being connected to a communication network, and comprising at least one end processing software module, hereafter known as a backend and belonging to a SIP cluster operating for an application, wherein each backend comprises a processing device according to claim 10.

16. A communication equipment capable of being connected to a communication network, and comprising at least one end processing software module, hereafter known as a backend and belonging to a SIP cluster operating for an application, wherein each backend comprises a processing device according to claim 11.
